(19) United States
(12) Patent Application Publication
(10) Pub. No.: US 2025/0335559 A1
(43) Pub. Date: Oct. 30, 2025

(54) METHOD FOR THE PERFORMANCE OF AN AUTHENTICATION PROCESS BY AN INDIVIDUAL SYSTEM USER

(71) Applicants: Uwe LEIBRECHT, Wörrstadt (DE); Kirstin WEBER-LEIBRECHT, Wörrstadt (DE)

(72) Inventors: Uwe LEIBRECHT, Wörrstadt (DE); Kirstin WEBER-LEIBRECHT, Wörrstadt (DE)

(21) Appl. No.: 18/696,537

(22) PCT Filed: Aug. 11, 2022
(86) PCT No.: PCT/DE2022/100591

§ 371 Date: Mar. 28, 2024

(30) Foreign Application Priority Data
Oct. 1, 2021 (DE) 10 2021 125 572.4

(51) Int. Cl. G06F 21/31

(52) U.S. Cl. CPC G06F 21/31

(57) ABSTRACT

A method for performing a human-machine authentication process by a user. An authentication system is provided using technical security systems for generating, managing and executing an authentication algorithm. This is achieved by an administrator implementing security fragments in the form of patterns, policies and/or algorithm templates, by virtue of the administrator managing the security fragments, by generating the algorithm from implemented security fragments and by linking to an authentication code. The authentication process is carried out by way of credentials and automated generation of temporary authentication data and enables transmission to the user, with a data exchange taking place between the security system and the authentication system through synchronization processes for the purpose of exchanging non-public data. The code is applied by the system user by virtue of the temporary authentication data being converted into a temporary input code and the technical security system carrying out an authentication check.

### TECHNICAL FIELD

The invention describes a method for human-machine authentication which defines the individual system user as an essential system element. For the purposes of conceptual classification within the meaning of this application, authentication should be understood as meaning the process of proving an identity, in contrast to authentication which refers to the process of checking the authenticity of this proof of identity. As a result, the resulting authorization refers to the resultant grant of access following the successfully proven identity. The invention is suited to being integrated into existing systems. The security of a system is enhanced by inputting an authentication code that must be input by the individual system user when prompted by the system. The method focuses on the cognitive performance of the individual system user and shows how this valuable individual human factor can be integrated into a technical authentication process in order to enhance security. Cognitive performance within the meaning of this invention comprises, for example, perception, attention, memory performance as well as the ability to learn and solve problems, adaptability, executive functions and cognitive flexibility.

Each individual system user has individual mental abilities. These can make an important contribution to the security of a system during the authentication process, regardless of the complexity of a system implementation. The invention describes a method for making it possible to use this human potential to enhance security in technical systems.

The invention uses technical elements/aids based on known cryptographic techniques and principles (cf. [014]). The system users apply them ad hoc during the authentication process. No deeper knowledge of cryptography, computer science or mechanics is required from the individual system user. The intellectual performance of the individual system user when using the system is inherent to the method and of central importance. It is at the heart of the authentication process. Use of the cognitive performance of the individual system user is the core element in making the authentication process more secure. The individual system user has individual choices. Depending on the need for security and individual performance, the individual system user can increase the complexity and thus the security standard.

### PRIOR ART

The basic method: An individual system user requests access to an action protected by a technical system. The stored authentication code is input by the individual system user and verified by the protected system. The other system actions depend on the verification result.

During input, prying eyes, cameras or so-called keyloggers (hardware or software used to log the user's inputs on the keyboard of a computer) can immediately pick up this authentication code and reuse it unjustifiably if the public input of the authentication code corresponds 1:1 to the stored secret authentication code.

The authentication code, which is sent to a certification authority by means of data transmission, e.g. via the Internet, can indeed be encrypted. However, if an attacker or unauthorized third party decrypts these data, these decrypted data still contain the stored authentication code 1:1.

Generally, there is always an increased security risk when inputting/transmitting the authentication code to perform security-critical actions of a system or during a security-critical operation, if the authentication code and the stored, secure and secret authentication code are identical.

There is also an increased security risk if the individual system user cannot be sure that the authentication code query is made by a legitimate system, in which case the keyword phishing is common here for example for fake websites, e-mails or short messages as allegedly trustworthy communication partners in an electronic communication.

In order to achieve higher security of the system during human-machine authentication, further software and/or hardware components are usually integrated into the authentication process as an additional security level according to the prior art. These include:
the carrying and administration of further hardware components (tokens),
the use of further software (2FA, MFA) or
the maintenance and administration of further lists (TAN, iTAN).

“Token” should be understood here as meaning a hardware or software component for identifying and authenticating users, usually as part of an access control system with two-factor authentication (2FA) as proof of identity of a user through a combination of two different and independent components (factors), such as a bank card and PIN at an ATM. As multi-factor authentication (MFA), this access authorization is verified by means of a plurality of independent features (factors). The transaction number (TAN) or indexed transaction number (iTAN) are one-time passwords that are primarily used in online banking.

Stringing together methods or mechanisms in which upstream and/or downstream security levels are run through in series increases the effort that must be made in order to reach the actual goal in the event of legitimate authentication. This means that an individual system user as a legitimate system user will have to spend more time and energy to achieve his or her actual goal, depending on the number of security levels.

In addition, the problem of the 1:1 assignment of input code and authentication code, as described in [005-010], remains. This exists for each individual upstream and/or downstream link in the security chain.

In the examples presented in [005-011], the human being is increasingly being replaced by technology as a significant factor in the authentication process. The human being increasingly only needs to transmit an output from technology element A to technology element B in order to reach the next security level. Extending the security chain by adding further security levels reduces the internalization (mental storage) of the secret authentication code. Furthermore, the importance of the human being in the entire security chain is increasingly being neglected.

There are methods that influence the manual input of the authentication code in such a way that the arrangement of the keys is changed at the moment of input. This makes it more difficult for users who, for example, remember a PIN code in the form of a pattern in the respective input field to use it. Examples include the following publications:

| Reference number | Brief description |
|---|---|
| CH 713 015 A2 | Input device and method |
| DE 296 13 938 U1 | Code input system for credit |
| | card payment systems and ATMs |
| DE 10 2004 002 128 A1 | Device and method for coded |
| | and/or non-coded commands |
| DE 10 2008 019 034 A1 | Method and device for |
| | determining an access code |
| DE 10 2009 020 207A1 | Input terminal and PIN capture method |
| DE 10 2009 012 011A1 | PIN or password input system |
| | for daily use in department stores |
| | to ensure discretion |

In the technical field of cryptography, extensive techniques, methods and standards have already been available for many years in order to make authentication on technical systems more secure and thus to make attacks on technical systems more difficult.

These include:
Challenge-response authentication (method for authenticating a participant based on knowledge using a problem (challenge) that must be solved by the participant (response) in order to prove that he or she knows defined information (shared secret)),
Salt (cryptography; a randomly selected string which is appended to given plain text before it is processed further (e.g. input into a hash function));
Salted challenge-response authentication mechanism (password-based challenge-response authentication mechanisms that allow a user to be authenticated with respect to a server),
Standard: ISO/IEC 9797 Message Authentication Codes [MACs] (to obtain the origin of data or messages and verify their integrity),
Message Authenticator Algorithm (MAA) (cryptographic functions for calculating a Message Authentication Code (MAC)) or
Standard: ISO-IEC-9798 Entity authentication (to confirm that an entity is actually the one it pretends to be).

The techniques and teachings of the established machine-machine authentication methods described in have hitherto not being able to be practically applied to human-machine authentication due to their complexity.

The publication U.S. Pat. No. 9,686,275 B2 discloses a technique for continuous user authentication through real-time fusion and correlation of a plurality of factors, wherein monitored user action data are continuously received from a computer and analyzed by a server in order to perform a number of modalities in order to thus be able to authenticate the user.

The publication U.S. Pat. No. 9,672,335 B2 discloses a method for user login to a computer, which introduces an additional thought-controlled user interface, in the case of which the user must respond to one or more input prompts. The user's responses to these input prompts are used to determine whether the user has the required level of cognitive functions to gain access to the computer system or continue an active login session.

The document U.S. Pat. No. 10,476,873 B2 discloses devices, systems and methods for detecting user identities and for password-free user authentication, for which the task is optionally a task for connecting the dots on the screen. The system monitors user interactions and user-specific features and then relies on such user-specific features as a means of user authentication.

In addition, a method for providing user access to a secure application is known from the publication EP 1 010 049 B1, in which at least one symbol is displayed as an authentication request to the user, the user manipulates the displayed symbol such that a code key can be generated on the basis of these manipulations of the displayed symbol, which code key allows the user to generate, in conjunction with stored authentication information, a result for authentication and grants user access if the result supports the authentication requirements of the secure application.

Against this background, the object of the present invention is to provide a method for performing an authentication process by an individual system user, with the targeted and practical integration of fast ad hoc calculations, which can be performed by machines for solving cryptographic problems that are required by the individual system user and are thus integrated into the authentication process. This challenge is the core of the present invention.

### DISCLOSURE OF THE INVENTION

### Advantages of the Invention

The invention emphasizes the potential of the individual system user to enhance security in authentication processes and clearly distinguishes itself from purely machine-based processes. Including the cognitive performance of the individual system user makes it possible to solve many current security problems in the human-bound authentication process. The invention offers existing and/or new technical systems an “individual human-machine authentication method” which:
1. makes cryptographically mature/established security mechanisms (cf. [014]) usable for individuals on an ad hoc basis,
2. uses the individual cognitive abilities of individuals to protect system security and makes it technically implementable,
3. is scalable and can be individually tailored to the cognitive performance of the individual system user. The individual system user as a system user and/or the system administration can thus increase the complexity in order to obtain a higher level of security, depending on their wishes and own need for security.
4. can combine individual security levels in one step, thus enabling parallel processing of a multiplicity of security levels in order to speed up the authentication process,
5. resolves the 1:1 relationship between input code and authentication code,
6. makes access by illegitimate attackers by spying more difficult, since the authentication can be done openly/publicly, without the individual system user having to fear that a third party can use the input that has been spied on in a targeted and resource-poor way,
7. distributes the physical input of the authentication code over the entire input field, which makes it much more difficult to derive inputs from pressure marks (e.g. dirt profiles, finger marks, etc.),
8. allows mutual authentication verification (human-machine) in order to make phishing (see [008]) more difficult,
9. is open to future cryptographic security techniques, methods and enhancements that can be flexibly integrated,
10. does not require the individual system user to have cryptography, computer science or mechanics capabilities,
11. can be easily implemented in existing security systems,
12. does not necessarily require the creation of new authentication codes, since existing authentication codes can be retained, and
13. strengthens the recollection of the authentication code, since the individual system user intensively deals with the authentication code during the authentication process and this is therefore memorized more deeply in long-term memory.

The following describes the method by which the above-mentioned advantages can be achieved. Use is made of reference signs that refer to the numbers used in the appended figures and to the appended list of reference signs.

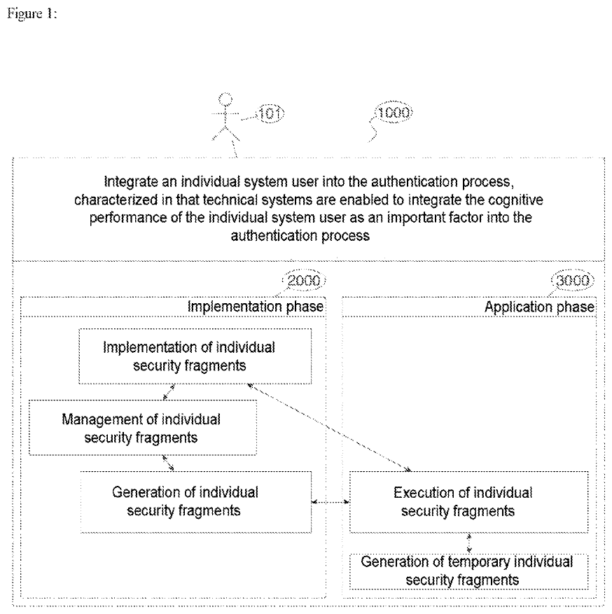

The method is henceforth referred to as individual algorithm-based multifactor authentication (for short: dopeIN or also dopeIN method) 1000 (FIG. 1), that is to say, the term dopeIN replaces the term individual algorithm-based multifactor authentication below and is used synonymously.

So that individuals can use the advantages of the dopeIN method 1000, it is necessary to define and establish terminology in order to distinguish it from known knowledge. The specific definitions of terms are noted immediately below when used in the continuous text and/or are supplemented with the prefix dopeIN.

In the context of individual algorithm-based multifactor authentication (dopeIN) 1000 (FIG. 1), technical systems are technical components (e.g. computers, microprocessors, machines, devices, components, etc.) in a larger unit (e.g. computer network, plant, building, device, machine, etc.) which interact in terms of their input and output variables for the purpose of “human-machine authentication”.

Security fragments are used for the authentication check. They can be created and/or verified as input and output variables within a single technical component in the technical system, and distributed, created and/or verified in a network of different technical components in technical systems.

The dopeIN method 1000 disclosed here distinguishes between two fundamental phases. The implementation phase 2000 and the application phase 3000. The application phase 3000 requires an implementation phase 2000.

In order to provide an expedient understanding of the use of individual algorithm-based multifactor authentication (dopeIN) 1000, the application phase 3000 is explained before the implementation phase 2000 and is schematically illustrated in the appendix in flowcharts in FIGS. 1 to 4.

The technical authentication and security systems 100, 200 may differ in the application and implementation phases 3000, 2000, but do not necessarily need to. For better understanding, the technical system is labeled 100 in the context of the application phase 3000 and 200 in the context of the implementation phase 2000.

The technical security systems 200 are used for the management, generation and/or synchronization/data exchange of algorithms for individual algorithm-based multifactor authentication.

The technical authentication systems 100 execute algorithms for individual algorithm-based multifactor authentication in order to protect security-related actions by means of additional cognitive performance of the individual system user 101 in the case of authentication.

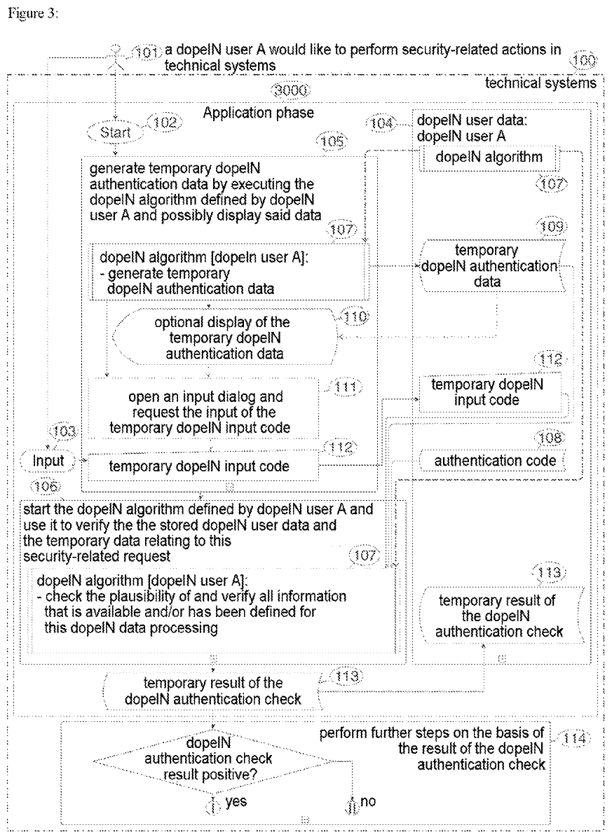

### Application Phase 3000 (FIG. 3)

A technical authentication system 100, in which a person must be legitimized 102 as an individual system user 101, uses, in authentication processes for data processing 105, 106, a common secret authentication code 108 previously defined in the implementation phase 2000 and a previously defined common secret dopeIN algorithm 107.

During system access to a security-related action 102 of an individual system user 101 using the dopeIN method 1000 (hereinafter referred to as dopeIN user 101), the technical authentication system 100 generates temporary authentication data 109 belonging to the requesting dopeIN user 101 and presents an input prompt 111 to the dopeIN user 101. These temporary authentication data 109 (hereinafter referred to as dopeIN authentication or dopeIN authentication data 109) are the result of the dopeIN data processing 105, by executing the dopeIN algorithm 107 of the requesting dopeIN user 101, at the request time 102.

If the dopeIN user 101 is able to correctly interpret the temporary dopeIN authentication data 109, 110, the user can determine the correct input code 112 at the request time 102 by his or her cognitive performance.

If the input prompt 111 from the technical authentication system 100 appears legitimate to the dopeIN user 101, the individual system user 101 tackles the prompt 111 and transmits the result of his or her cognitive performance to the requesting technical authentication system 100 by means of an input 103. These input data 112 of the dopeIN user 101 are referred to as the temporary dopeIN input code 112 below.

The technical authentication system 100 checks the individual security fragments, the temporary dopeIN input code 112 of the dopeIN user 101 on the basis of the generated temporary dopeIN authentication data 109, the jointly agreed secret authentication code 108 and the individually underlying dopeIN algorithm 107 of the dopeIN method 1000, by executing the dopeIN algorithm 107, and provides a temporary result 113 of this dopeIN authentication check 106 as output.

The temporary result 113 of the authentication check 106 can now be used to determine the further steps of the system process 114 on the basis of the result 113. As an example, in the case of a positive temporary result 113, the desired security-related action 102 could be executed immediately. In the negative case, the dopeIN user 101 could receive a warning message and then further system access of the dopeIN user 101 could be blocked.

The table below summarizes the individual steps of the application phase 3000 again, as shown in FIG. 3.
dopeIN application phase: Human⇔Machine

Human:

| | |
|---|---|
| ⬇ | * executes a security-related action 102 |
| | on a technical authentication system 100 that has |
| | implemented the dopeIN method 1000 |

Machine:

| | |
|---|---|
| ⬇ | * executes 105 the respective dopeIN algorithm |
| | 107 of the respective dopeIN user 101 |
| | X generates the temporary authentication data 109 |
| | * optionally displays 110 these temporary |
| | authentication data 109 |
| | * stores 104 these temporary authentication |
| | data 109 for further dopeIN data processing |
| | * opens an input dialog and prompts 111 the |
| | input of the temporary dopeIN input code 112 |

Human:

| | |
|---|---|
| ⬇ | * cognitively determines, on the basis of the |
| | previously defined dopeIN algorithm 107, the |
| | security fragment that is needed by the |
| | machine for the subsequent dopeIN data |
| | processing 106 in order to confirm correct |
| | authentication (see [001]) and report it as an |
| | output 113 |
| | * adds a further security fragment (temporary |
| | dopeIN input code 112) to the dopeIN data |
| | processing 106 by means of an input 103 |

Machine:

| ⬇ | * executes the respective dopeIN algorithm | |
|---|---|---|
| | 107 of the respective dopeIN user 101 in order | |
| | to check the plausibility of and verify 106 | |
| | all fragments of the security-related system | |
| | request 102 | |
| | ⬇ | * checks all individual security fragments |
| | | for plausibility (107, 108, 109, 112) |
| | ⬇ | * checks whether all security fragments fit together 106 |
| | ⬇ | * verifies 106 the content of all security |
| | | fragments on the basis of their definition |
| | ⬇ | * generates the temporary result of the dopeIN |
| | | authentication check as an output 113 |
| | | based on the dopeIN data processing 106 |

* performs 114 further steps on the basis of
the temporary result 113 of the dopeIN
authentication check 106

The following are potential areas of application for the technical implementation of the dopeIN application phase: Human⇔Machine:
Potential areas of applications for the dopeIN application phase: Human⇔Machine

### Example 1: Authentication of a Bank Customer at an ATM

Human:

| ⬇ | * executes a security-related action 102 on a | |
|---|---|---|
| | technical authentication system 100 that has | |
| | implemented the dopeIN method 1000 | |
| | → | A bank customer wants to use his or her |
| | | EC card to make a transfer at an ATM |
| | | belonging to his or her bank. To do this, the |
| | | customer inserts his or her EC card into |
| | | the ATM. |

Machine:

| ⬇ | * executes 105 the respective dopeIN algorithm | |
|---|---|---|
| | 107 of the respective dopeIN user 101 | |
| | → | Using the reader of the ATM, it is determined |
| | | that it is a legitimate EC card of the bank |
| | | customer and secure data exchange takes |
| | | place with the bank's security server. The |
| | | bank's security server executes 105 the |
| | | associated dopeIN algorithm 107 of the |
| | | requesting bank customer (dopeIN user) 101. |
| | * generates the temporary authentication data 109 | |
| | * stores 104 these temporary authentication data | |
| | 109 for further dopeIN data processing | |
| | → | By executing the associated dopeIN algorithm |
| | | 107, the temporary authentication data |
| | | 109 are generated and stored on the security server. |
| | * optionally displays 110 these temporary authentication data 109 | |
| | * opens an input dialog and prompts 111 the input | |
| | of the temporary dopeIN input code 112 | |
| | → | The bank's security server then sends a secure |
| | | data packet containing the temporary |
| | | authentication data 109 to the ATM. These |
| | | temporary authentication data 109 are then |
| | | displayed on the ATM. At the same time, |
| | | the bank customer is asked to input the |
| | | temporary dopeIN input code 112. |

Human:

| ⬇ | * cognitively determines, on the basis of the | |
|---|---|---|
| | previously defined dopeIN algorithm 107, the | |
| | security fragment that is needed by the machine | |
| | for the subsequent dopeIN data | |
| | processing 106 in order to confirm correct | |
| | authentication (see [001]) and report it as an | |
| | output 113 | |
| | → | The bank customer checks the temporary |
| | | authentication data 109 displayed by the |
| | | ATM for plausibility in order to then determine |
| | | the temporary dopeIN input code 112 |
| | | using cognitive performance. |
| | * adds a further security fragment (temporary | |
| | dopeIN input code 112) to the dopeIN data | |
| | processing 106 by means of an input 103 | |
| | → | The bank customer inputs the temporarily |
| | | determined dopeIN input code 112 at the |
| | | ATM and confirms his or her input. |

Machine:

| ⬇ | * executes the respective dopeIN algorithm 107 | |
|---|---|---|
| | of the respective dopeIN user 101 in order | |
| | to check the plausibility of and verify 106 all | |
| | fragments of the security-related system | |
| | request 102 | |
| | → | By confirming the input of the temporary |
| | | dopeIN input code 112 at the ATM, all |
| | | available security fragments of this security- |
| | | related action are sent by means of a |
| | | secure data transmission from the ATM to |
| | | the bank's security server. The latter then |
| | | executes 106 the associated dopeIN algorithm |
| | | 107 of the requesting bank customer |
| | | (dopeIN user) 101. |
| | ⬇ | *checks all individual security fragments for |
| | | plausibility (107, 108, 109, 112) |
| | ⬇ | * checks whether all security fragments fit together 106 |
| | ⬇ | * verifies 106 the content of all security |
| | | fragments on the basis of their definition |
| | ⬇ | * generates the temporary result of the dopeIN |
| | | authentication check as an output 113 |
| | | based on the dopeIN data processing 106 |
| | * performs 114 further steps on the basis of | |
| | the temporary result 113 of the dopeIN | |
| | authentication check 106 | |
| | → | Depending on the checking result of the |
| | | security-related request for authentication at |
| | | an ATM, further previously defined steps |
| | | can now be performed. If the result is |
| | | positive, access to all bank customer functions |
| | | of the ATM may be available, for |
| | | example. In the negative case, a new authentication |
| | | can be requested from the bank |
| | | customer, for example. |

### Example 2: Confirmation of Purchase by an Already Authenticated Web Shop User as an Individual System User 101

Human:

| ⬇ | * executes a security-related action 102 on a | |
|---|---|---|
| | technical authentication system 100 that has | |
| | implemented the dopeIN method 1000 | |
| | → | An already authenticated web shop user |
| | | would like to order his filled online shopping |
| | | cart for payment. To do this, the web shop |
| | | user confirms a corresponding input prompt |
| | | from the web shop in his or her browser. |

Machine:

| ⬇ | * executes 105 the respective dopeIN algorithm | |
|---|---|---|
| | 107 of the respective dopeIN user 101 | |
| | → | The user data relating to the web shop |
| | | user defined that paid transactions are |
| | | additionally secured with an individual |
| | | algorithm-based multifactor authentication |
| | | (dopeIN) 1000, which is why the associated |
| | | dopeIN algorithm 107 of the web shop |
| | | user (dopeIN user) 101 is executed 105 |
| | | on the security server of the web shop |
| | | provider. |
| | * generates the temporary authentication data 109 | |
| | * stores 104 these temporary authentication data | |
| | 109 for further dopeIN data processing | |
| | → | By executing the associated dopeIN algorithm |
| | | 107, the temporary authentication data 109 are |
| | | generated and stored on the security server |
| | | of the web shop provider. |
| | * optionally displays 110 these temporary authentication data 109 | |
| | * opens an input dialog and prompts 111 the input | |
| | of the temporary dopeIN input code 112 | |
| | → | The security server of the web shop provider |
| | | then sends a secure data packet |
| | | containing the temporary authentication data |
| | | 109 to the web server of the web shop |
| | | provider by means of a secure data |
| | | transmission. As a result, these temporary |
| | | authentication data 109 are then displayed in |
| | | the browser of the web shop user. At the |
| | | same time, the web shop user is asked to input |
| | | the temporary dopeIN input code 112. |

Human:

| ⬇ | * cognitively determines, on the basis of the previously | |
|---|---|---|
| | defined dopeIN algorithm 107, the | |
| | security fragment that is needed by the machine | |
| | for the subsequent dopeIN data | |
| | processing 106 in order to confirm correct | |
| | authentication (see [001]) and report it as an | |
| | output 113 | |
| | → | The web shop user checks the temporary |
| | | dopeIN authentication data 109 displayed by |
| | | the web shop for plausibility in order to |
| | | then determine the temporary dopeIN input |
| | | code 112 using cognitive performance. |
| | * adds a further security fragment (temporary | |
| | dopeIN input code 112) to the dopeIN data | |
| | processing 106 by means of an input 103 | |
| | → | The web shop user inputs the temporarily |
| | | determined dopeIN input code 112 to his |
| | | browser and confirms his or her input. |

Machine:

| ⬇ | * executes the respective dopeIN algorithm 107 | |
|---|---|---|
| | of the respective dopeIN user 101 in order | |
| | to check the plausibility of and verify 106 all | |
| | fragments of the security-related system | |
| | request 102 | |
| | → | By confirming the input of the temporary |
| | | dopeIN input code 112 in the browser of the |
| | | web shop user, all available security fragments |
| | | of this security-related action are sent |
| | | by means of a secure data transmission from |
| | | the browser of the web shop user to the |
| | | web server of the web shop provider and from |
| | | there to the security server of the web |
| | | shop provider. The latter then executes 106 |
| | | the associated dopeIN algorithm 107 of the |
| | | requesting web shop user (dopeIN user) 101. |
| | ⬇ | * checks all individual security fragments |
| | | for plausibility (107, 108, 109, 112) |
| | ⬇ | * checks whether all security fragments fit together 106 |
| | ⬇ | * verifies 106 the content of all security |
| | | fragments on the basis of their definition |
| | ⬇ | * generates the temporary result of the |
| | | dopeIN authentication check as an output 113 |
| | | based on the dopeIN data processing 106 |
| | * performs 114 further steps on the basis of the | |
| | temporary result 113 of the dopeIN authentication check 106 | |
| | → | Depending on the checking result of this |
| | | security-related request from the web shop |
| | | user, further previously defined steps can |
| | | now be performed. If the result is positive, |
| | | the confirmation of purchase of the items |
| | | in the shopping cart can be issued, for |
| | | example. In the negative case, the web shop |
| | | customer can be blocked for the next 15 |
| | | minutes, for example, with corresponding |
| | | email notification to the web shop user's |
| | | email address. |

### Example 3: Access Control to a Safety Laboratory

Human:

| ⬇ | * executes a security-related action 102 on a | |
|---|---|---|
| | technical authentication system 100 that has | |
| | implemented the dopeIN method 1000 | |
| | → | An employee of a company wants to enter |
| | | a safety laboratory on the company |
| | | premises. For this purpose, the employee holds |
| | | his or her company ID in the form of a |
| | | chip card on the corresponding reader of |
| | | the secure laboratory entrance. |

Machine:

| ⬇ | * executes 105 the respective dopeIN algorithm | |
|---|---|---|
| | 107 of the respective dopeIN user 101 | |
| | → | The correct identification of the chip card on |
| | | the reader then sends a secure data packet |
| | | to the security server used in the company by |
| | | means of a secure data transmission. This |
| | | security server executes 105 the associated |
| | | dopeIN algorithm 107 of the requesting |
| | | employee (dopeIN user) 101. |
| | * generates the temporary authentication data 109 | |
| | * stores 104 these temporary authentication data | |
| | 109 for further dopeIN data processing | |
| | → | By executing the associated dopeIN algorithm |
| | | 107, the temporary authentication data |
| | | 109 are generated and stored on the security server. |
| | * optionally displays 110 these temporary | |
| | authentication data 109 | |
| | * opens an input dialog and prompts 111 the input | |
| | of the temporary dopeIN input code 112 | |
| | → | With the aid of a text message to the employee's |
| | | company cell phone, the employee |
| | | receives the temporary authentication data |
| | | 109 and the advice that he/she should input |
| | | his or her temporarily determined dopeIN |
| | | input code 112 on the keypad next to the |
| | | security door of the laboratory. The employee |
| | | also receives the advice to confirm 111 |
| | | this input with the finger scanner attached to the keypad. |

Human:

| ⬇ | * cognitively determines, on the basis of the | |
|---|---|---|
| | previously defined dopeIN algorithm 107, the | |
| | security fragment that is needed by the | |
| | machine for the subsequent dopeIN data | |
| | processing 106 in order to confirm correct | |
| | authentication (see [001]) and report it as an | |
| | output 113 | |
| | → | The employee reads and checks the delivery |
| | | and content of the text message on his or |
| | | her company cell phone for plausibility |
| | | in order to then determine the temporary |
| | | dopeIN input code 112 using cognitive performance. |
| | * adds a further security fragment (temporary | |
| | dopeIN input code 112) to the dopeIN data | |
| | processing 106 by means of an input 103 | |
| | → | The employee follows the instructions in |
| | | the previously mentioned text message, |
| | | inputs the temporarily determined dopeIN |
| | | input code 112 on the keypad of the security |
| | | door mentioned and confirms his or her input |
| | | by means of a fingerprint of his or her |
| | | left ring finger on the associated fingerprint scanner. |

Machine:

| ⬇ | * executes the respective dopeIN algorithm 107 | |
|---|---|---|
| | of the respective dopeIN user 101 in order | |
| | to check the plausibility of and verify 106 all | |
| | fragments of the security-related system | |
| | request 102 | |
| | → | Through the correct identification of the |
| | | employee's fingerprint on the fingerprint |
| | | scanner, the temporary dopeIN input code |
| | | 112 input on the keypad is sent to the |
| | | security server used in the company, which |
| | | then executes 106 the associated dopeIN |
| | | algorithm 107 of the requesting employee (dopeIN user) 101. |
| | ⬇ | * checks all individual security fragments |
| | | for plausibility (107, 108, 109, 112) |
| | ⬇ | = * checks whether all security fragments fit together 106 |
| | ⬇ | 11 * verifies 106 the content of all security |
| | | fragments on the basis of their definition |
| | ⬇ | * generates the temporary result of the dopeIN |
| | | authentication check as an output 113 |
| | | based on the dopeIN data processing 106 |
| | * performs 114 further steps on the basis of the | |
| | temporary result 113 of the dopeIN authentication check 106 | |
| | → | Depending on the checking result of the |
| | | security-related request to open the security |
| | | door to the safety laboratory, further previously |
| | | defined steps can now be performed. If |
| | | the result is positive, the security door can |
| | | be opened, for example, or, in the negative |
| | | case, an alarm can sound and the security door |
| | | can remain closed. |

### Example 4: Deactivation of the Immobilizer of an Automobile

Human:

| ⬇ | * executes a security-related action 102 on a | |
|---|---|---|
| | technical authentication system 100 that has | |
| | implemented the dopeIN method 1000 | |
| | → | An automobile driver wants to deactivate the |
| | | immobilizer on his or her automobile in |
| | | order to start the automobile's engine. To do |
| | | this, the driver actuates the start button in |
| | | his or her automobile. |

Machine:

| ⬇ | * executes 105 the respective dopeIN algorithm | |
|---|---|---|
| | 107 of the respective dopeIN user 101 | |
| | → | Using the user-defined automobile key stored |
| | | in the on-board computer and the start |
| | | button pressed on the automobile, the |
| | | on-board computer recognizes that it is a |
| | | legitimate automobile key of the automobile |
| | | driver and executes 105 the associated |
| | | dopeIN algorithm 107 of the requesting |
| | | automobile driver (dopeIN user) 101. |
| | * generates the temporary authentication data 109 | |
| | * stores 104 these temporary authentication data | |
| | 109 for further dopeIN data processing | |
| | → | By executing the associated dopeIN algorithm |
| | | 107, the temporary authentication data |
| | | 109 are generated and stored in the |
| | | automobile's on-board computer. |
| | * optionally displays 110 these temporary authentication data 109 | |
| | * opens an input dialog and prompts 111 the input | |
| | of the temporary dopeIN input code 112 | |
| | → | These temporary authentication data 109 are |
| | | then displayed on the automobile's on- |
| | | board display. At the same time, the automobile |
| | | driver is asked to input the temporary |
| | | dopeIN input code 112. |

Human:

| ⬇ | * cognitively determines, on the basis of the | |
|---|---|---|
| | previously defined dopeIN algorithm 107, the | |
| | security fragment that is needed by the | |
| | machine for the subsequent dopeIN data | |
| | processing 106 in order to confirm correct authentication | |
| | (see [001]) and report it as an output 113 | |
| | → | The automobile driver checks the temporary |
| | | authentication data 109 displayed on the |
| | | on-board display in order to then determine |
| | | the temporary dopeIN input code 112 |
| | | using cognitive performance. |
| | * adds a further security fragment (temporary | |
| | dopeIN input code 112) to the dopeIN data | |
| | processing 106 by means of an input 103 | |
| | → | The automobile driver inputs the temporarily |
| | | determined dopeIN input code 112 on the |
| | | automobile's on-board display and confirms his or her input. |

Machine:

| ⬇ | * executes the respective dopeIN algorithm 107 | |
|---|---|---|
| | of the respective dopeIN user 101 in order | |
| | to check the plausibility of and verify 106 all | |
| | fragments of the security-related system | |
| | request 102 | |
| | → | By confirming the input of the temporary |
| | | dopeIN input code 112 on the on-board |
| | | display, the on-board computer then executes |
| | | 106 the dopeIN algorithm 107 of the |
| | | automobile driver (dopeIN user) 101 that is |
| | | associated with the automobile key. |
| | ⬇ | * checks all individual security fragments |
| | | for plausibility (107, 108, 109, 112) |
| | ⬇ | * checks whether all security fragments fit together 106 |
| | ⬇ | * verifies 106 the content of all security |
| | | fragments on the basis of their definition |
| | ⬇ | * generates the temporary result of the dopeIN |
| | | authentication check as an output 113 |
| | | based on the dopeIN data processing 106 |
| | * performs 114 further steps on the basis of | |
| | the temporary result 113 of the dopeIN | |
| | authentication check 106 | |
| | → | Depending on the checking result of the |
| | | security-related request to deactivate the |
| | | immobilizer, further previously defined steps |
| | | can now be performed. If the result is |
| | | positive, the immobilizer can be deactivated, |
| | | for example, in order to start the engine in |
| | | the next step. In the negative case, an |
| | | error message stating that no correct |
| | | authentication has taken place can be displayed |
| | | on the on-board display, for example. |

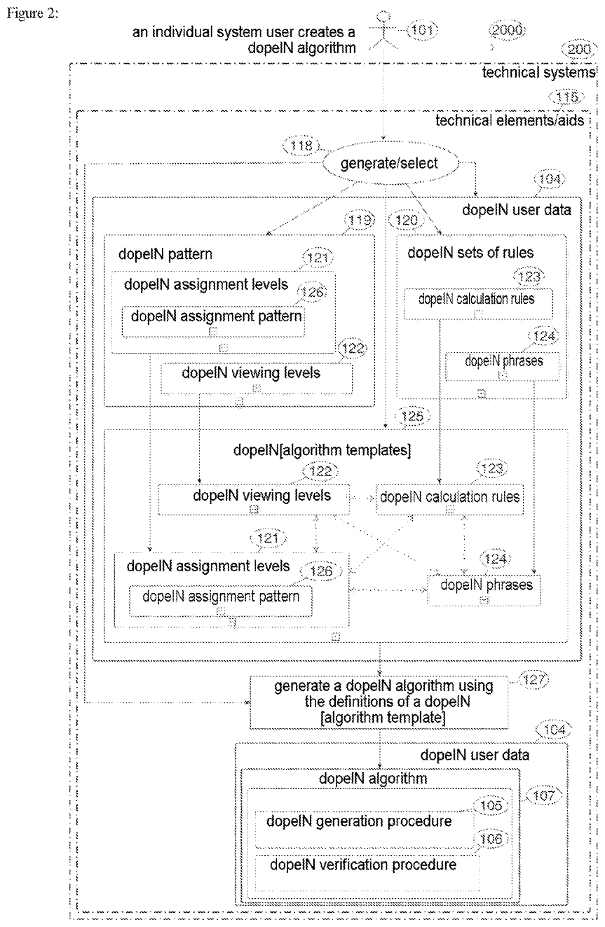

### Implementation Phase 2000, as Shown in FIG. 2

In order to use individual algorithm-based multifactor authentication (dopeIN) 1000 between an individual system user 101 and a technical authentication system 100, technical elements/aids 115 must be created and managed beforehand. This is done during the implementation phase 2000.

An individual system user 101 creates an individual software-based or hardware-based dopeIN algorithm 107 using his or her cognitive abilities, a technical security system 200 and technical elements/aids 115. For this, the individual system user 101 does not require any background knowledge in cryptography, computer science or mechanics.

The dopeIN algorithm 107 is the technical product or construct that defines data processing processes 105, 106 with the aim of secure “individual human-machine authentication”. The dopeIN algorithm 107 is a separate security fragment in individual algorithm-based multifactor authentication (dopeIN) 1000.

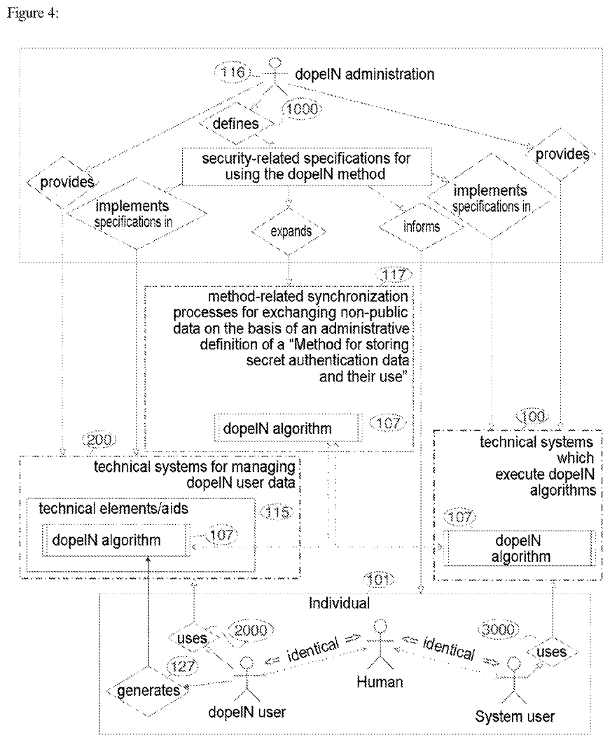

dopeIN administration 116 is understood as meaning an administration unit (human and/or organization) that implements the dopeIN method 1000 in its security process and organizes the personnel and technical requirements 2000, 3000. Method-related synchronization processes for exchanging non-public data, such as a native “method for storing secret authentication data and their use” 117, are expanded to include the dopeIN method 1000 (cf. FIG. 4).

The dopeIN administration 116 must weigh up when and in what complexity dopeIN algorithms 107 are used and who defines and manages them. The advantages and disadvantages of individual freedom of design must be weighed up against systematic restrictions and regulations (cf. FIG. 4).

The dopeIN administration 116 also defines hardware and/or software components of technical authentication systems 100 and technical security systems 200 and assigns how and where:
the technical elements/aids 115 for creating and managing dopeIN algorithms 107 are made available,
dopeIN user data 104 are managed,
dopeIN algorithms 107 are generated 127,
dopeIN algorithms 107 are executed 105, 106,
the temporary authentication data 109 are managed,
the respective optional dopeIN displays 110 are presented,
the respective inputs of the dopeIN input codes 103 are made and
how the respective outputs of the dopeIN data processing operations 105, 106, 127 should be interpreted and managed.

The advantages and disadvantages of internal or external data processing processes and services must be weighed up against each other (cf. FIG. 2, FIG. 3, FIG. 4).

The dopeIN administration 116 also decides when and how further techniques, methods and standards (cf. [009], [014]) should be integrated in the context of implementing individual algorithm-based multifactor authentication (dopeIN).

On the basis of a dopeIN algorithm 107, temporary authentication data 109 are generated (see dopeIN generation procedure) 105 and analyzed and verified in the subsequent checking process (see dopeIN verification procedure) 106. The dopeIN algorithm 107 complies with at least the following security aspects:
It integrates at least one common agreed secret authentication code 108 which is known to both parties, i.e. the individual system user 101 and the technical authentication system 100.
It is itself a security fragment of the authentication checks.
It includes a user-defined dopeIN generation procedure 105. This generates a temporary security fragment (dopeIN authentication data) 109 during execution.
It includes a user-defined dopeIN verification procedure 106. This performs logical checks of different input parameters (temporary authentication data 109, temporary dopeIN input code 112, and secret authentication code 108) in relation to each other and provides a temporary result of these checks as an output 113.

The table below summarizes the individual steps of the implementation phase 2000.

### DopeIN Implementation Phase: Human⇔Machine

Human (dopeIN administration 116)
* implements the dopeIN method 1000 in the
security process and informs the individual
system users 101 about the content and application
of individual algorithm-based multifactor
authentication (dopeIN) 1000 (FIG.1, cf. FIG. 4)
* provides or specifies the technical prerequisites
for defining and interpreting dopeIN
algorithms 107 (cf. FIG. 4)
Human (dopeIN user 101)
* produces, selects 118, generates 127 or receives
118 a dopeIN algorithm 107 which
* itself represents a security fragment of the dopeIN
data processing operations 105, 106, 127
* includes a user-defined dopeIN generation
procedure 105 which generates a temporary
security fragment (dopeIN authentication data)
109 for the pending dopeIN data processing
106 when executed
* includes a user-defined dopeIN verification
procedure 106 which performs logical
verifications of different input parameters
(security fragments) in relation to each other
when executed and provides the result 113 of
these verifications 106 as a temporary output
(cf. FIG. 3)
Machine:
* constitutes the technical hardware and software
100, 200, 115 for generating, managing
(creating, editing, modifying, saving, and deleting)
and executing security fragments of
individual algorithm-based multifactor authentication
(dopeIN) 1000. (cf. FIG.4)

In order to enable an individual system user 101 without knowledge of cryptography, computer science or mechanics to generate and manage individual security fragments of individual algorithm-based multifactor authentication (dopeIN), further technical elements/aids 115 are required. (cf. FIG. 2)

These technical elements/aids 115 include:
dopeIN sets of rules 120,
   dopeIN calculation rules 123,
   dopeIN phrases 124,
dopeIN patterns 119,
   dopeIN viewing levels 122,
   dopeIN assignment levels 121,
   dopeIN assignment patterns 126 and
dopeIN[algorithm templates] 125.

In order to generate 127 dopeIN algorithms 107, templates, so-called dopeIN[algorithm templates] 125, can be used or individually generated 118. These dopeIN[algorithm templates] 125 contain the framework of a dopeIN algorithm 107, but not secret information such as authentication codes 108.

With the aid of dopeIN sets of rules 120, dopeIN phrases 124 and dopeIN calculation rules 123 to be applied are generated. This allows simple, but also very complex, calculation or data processing operations 105, 106, 107 to be represented.

The complexity is selected by the dopeIN user 101 according to his or her individual security needs and his or her own cognitive abilities.

The generation and use of dopeIN sets of rules 120, dopeIN calculation rules 123 and dopeIN phrases 124 is the responsibility of the dopeIN user 101 and, if necessary, is guided by the specifications of the dopeIN administration 116 that uses or implements the dopeIN method 1000 (cf. FIG. 4).

dopeIN calculation rules 123 control in the simplest way how calculation operations should be performed by the technical authentication system 100 by executing the dopeIN algorithm 107. They also define how the individual system user 101 should proceed.

Examples of different dopeIN calculation rules 123 are outlined below, in which case reference numbers were deliberately omitted. They range from very simple (level 1a) to difficult (level 2c). The operators of the calculation tasks consist of single-digit decimal numbers (0-9).

Level 1a dopeIN calculation rules:
1. Regardless of the operator or operand, calculations are always performed from left to right and a result is determined for every two operands and one operator.
2. If a result is a two-digit decimal number, only the units digit is used for the solution.
3. There are only two operands and one operator.
4. Only addition (+) and subtraction (−) are allowed as operators.
5. If the result of a calculation operation is <0, the number 10 is added to the first operand and is used for further calculation.

### Examples Include:

| Calculation | Solution | dopeIN | Explanation of |
|---|---|---|---|
| problem | process | input code | the solution |
| 1 + 1 = ? | 1 + 1 = 2 | 2 | The units digit |
| 6 − 3 = ? | 6 − 3 = 3 | 3 | corresponds to the solution |
| 1 + 9 = ? | 1 + 9 = 10 | 0 | |
| 9 + 7 = ? | 9 + 7 = 16 | 6 | |
| 2 − 3 = ? | 2 − 3 => | 9 | If the result <0, 10 is added |
| | 10 + 2 − 3 => | | to the first operand. The units |
| | 12 − 3 = 9 | | digit corresponds to the |
| 0 − 6 = ? | 0 − 6 => | 4 | solution |
| | 10 + 9 − 6 => | | |
| | 10 − 6 = 4 | | |

Level 1b dopeIN Calculation Rules:

Note: All level 1a: (1-5) dopeIN calculation rules apply; point 6 also applies:
1. Regardless of the operator or operand, calculations are always performed from left to right and a result is determined for every two operands and one operator.
2. If a result is a two-digit decimal number, only the units digit is used for the solution.
3. There are only two operands and one operator.
4. Only addition (+) and subtraction (−) are allowed as operators.
5. If the result of a calculation operation is <0, the number 10 is added to the first operand and is used for further calculation.
6. Operators for multiplication (*) and division (/) are integrated. However, they are used as placeholders, where (*) is used as the placeholder for addition and (/) is used as the placeholder for subtraction.

### Examples Include:

| Calculation | Solution | dopeIN | Explanation of |
|---|---|---|---|
| problem | process | input code | the solution |
| 1 + 9 = ? | 1 + 9 = 10 | 0 | The unis digit corresponds |
| | | | to the solution |
| 1 + 9 = ? | 1 + 9 => | 0 | (*) is interpreted as (+). The units |
| | 1 + 9 = 10 | | digit corresponds to the solution |
| 4/6 = ? | 4/5 => | 9 | (/) is interpreted as (−). If the result |
| | 4 − 5 => | | <0, 10 is added to the first operand. |
| | 10 + 4 − 5 => | | The units digit corresponds |
| | 14 − 5 = 9 | | to the solution. |

Level 1c dopeIN Calculation Rules:

Note: The level 1a: (1-3 and 5) dopeIN calculation rules apply; points 4 and 6 are amended or supplemented:
1. Regardless of the operator or operand, calculations are always performed from left to right and a result is determined for every two operands and one operator.
2. If a result is a two-digit decimal number, only the units digit is used for the solution.
3. There are only two operands and one operator.
4. Only addition (+), subtraction (−) and multiplication (*) are allowed as operators.
5. If the result of a calculation operation is <0, the number 10 is added to the first operand and is used for further calculation.
6. Division (/) is integrated. However, it is used as a placeholder for subtraction.

### Examples Include:

| Calculation | Solution | dopeIN input | |
|---|---|---|---|
| problem | process | code | Explanation of the solution |
| 3 [symbol] 9 = ? | 3 [symbol] 9 = 27 | 7 | The units digit corresponds to the solution |
| 7 [symbol] 8 = ? | 7 [symbol] 8 = 56 | 6 | |
| 3/7 = ? | 3/7 => | 6 | ( [symbol] ) is interpreted as ( [symbol] ) [symbol] the result [symbol] 10 is added to the first operand. The units |
| | 3 − 7 => | | digit corresponds to the solution |
| | 10 [symbol] 3 − 7 => | | |
| | 13 − 7 = 6 | | |

[symbol]

indicates data missing or illegible when filed

Level 1d dopeIN Calculation Rules:

Note: The level 1c: (1, 3, 4, 5, 6) dopeIN calculation rules apply; point 2 is amended:
1. Regardless of the operator or operand, calculations are always performed from left to right and a result is determined for every two operands and one operator.
2. If a result is a two-digit decimal number >10, only the tens digit is used for the solution.
3. There are only two operands and one operator.
4. Only addition (+), subtraction (−) and multiplication (*) are allowed as operators.
5. If the result of a calculation operation is <0, the number 10 is added to the first operand and is used for further calculation.
6. Division (/) is integrated. However, it is used as a placeholder for subtraction.

### Examples Include:

| Calculation | Solution | dopeIN input | |
|---|---|---|---|
| problem | process | code | Explanation of the solution |
| 3 [symbol] 9 = ? | 3 [symbol] 9 = 27 | 2 | If the result is >10, the tens digit corresponds to the solution |
| 7 [symbol] 8 = ? | 7 [symbol] 8 = 56 | 5 | |
| 1/1 = ? | 1/1 => | 0 | ( [symbol] ) is interpreted as ( [symbol] ). If the result [symbol] 10, the units digit corresponds to the solution |
| 5 [symbol] 2 = ? | 5 [symbol] 2 = 10 | 0 | If the result [symbol] 10, the units digit corresponds to the solution |
| 5 [symbol] 7 = ? | 5 [symbol] 7 = 12 | 1 | If the result is >10, the tens digit corresponds to the solution |
| 8/9 = ? | 8/9 => | 9 | ( [symbol] ) is interpreted as ( [symbol] ). If the result is <0. 10 is added to the first operand. The units |
| | 8 − 9 => | | digit corresponds to the solution. |
| | 10 [symbol] 8 − 9 => | | |
| | 18 − 9 = 9 | | |

[symbol]

indicates data missing or illegible when filed

Level 1e dopeIN Calculation Rules:

Note: The level 1a: (1 and 3) dopeIN calculation rules apply; points 2, 4, 5 are amended:
1. Regardless of the operator or operand, calculations are always performed from left to right and a result is determined for every two operands and one operator.
2. If a result is a two-digit decimal number, the cross-sum is formed and the units digit of this cross-sum is used as the result.
3. There are only two operands and one operator.
4. Only addition (+) and multiplication (*) are allowed as operators.
5. Operators for subtraction (−) and division (/) are integrated. However, they are used as placeholders, where (−) and (/) are used as placeholders for addition.

### Examples Include:

| Calculation | Solution | dopeIN input | |
|---|---|---|---|
| problem | process | code | Explanation of the solution |
| 5 [symbol] 5 = ? | 5 [symbol] 5 = 25 => | 7 | If the result is two-digit result, the cross-sum is formed. The units digit corresponds to |
| | 2 [symbol] 5 = 7 | | the solution |
| 7 [symbol] 7 = ? | 7 [symbol] 7 = 49 => | 3 | |
| | 4 [symbol] 9 = 13 | | |
| 9 − 9 = ? | 9 − 9 => | 9 | ( [symbol] ) is interpreted as ( [symbol] ). If the result is two-digit result, the cross-sum is formed. The |
| | 9 [symbol] 9 = 18 => | | units digit corresponds to the solution |
| | 1 [symbol] 8 = 9 | | |
| 1/9 = ? | 1/9 => | 1 | ( [symbol] ) is interpreted as ( [symbol] ) [symbol] . If the result is two-digit result, the cross-sum is |
| | 1 [symbol] 9 = 10 => | | formed. The units digit corresponds to the solution |
| | 1 [symbol] 0 = 1 | | |

[symbol]

indicates data missing or illegible when filed

Level 2a dopeIN Calculation Rules:
1. Regardless of the operator, calculations are always performed from left to right; the “multiplication and division before addition and subtraction rule” is ignored; in this case, every two operands and one operator form an intermediate result until a result can be determined.
2. If an intermediate result or result is a two-digit decimal number >18, only the units digit is used for the intermediate solution or solution.
3. There are a plurality of operands and a plurality of operators.
4. Only addition (+) and subtraction (−) are allowed as operators.
5. If the result of a calculation operation is <0, the number 10 is added to the first operand and is used for further calculation.

### Examples Include:

| Calculation | Solution | dopsIN input | |
|---|---|---|---|
| problem | process | code | Explanation of the solution |
| 1 + 9 + 2 = ? | 1 + 9 + 2 => | 2 | The units digit corresponds to the solution |
| | 10 + 2 = 12 | | |
| 5 − 6 + 1 = ? | 5 − 6 + 1 => | 0 | If the result <0, 10 is added to the first operand. The units digit corresponds |
| | 10 + 5 − 6 + 1 => | | to the solution |
| | 15 − 6 + 1 => | | |
| | 9 + 1 = 10 | | |
| 2 − 3 + 9 = ? | 2 − 3 + 9 => | 8 | If the result <0, 10 is added to the first operand. The units digit corresponds |
| | 10 + 2 − 3 + 9 => | | to the solution |
| | 12 − 3 + 9 => | | |
| | 9 + 9 = 18 | | |
| 4 − 1 + 2 − 3 = ? | 4 − 1 + 2 − 3 => | 2 | The units digit corresponds to the solution |
| | 3 + 2 − 3 => | | |
| | 5 − 3 = 2 | | |

Level 2b dopeIN Calculation Rules:

Note: All level 2a: (1-5) dopeIN calculation rules apply; point 6 also applies:
1. Regardless of the operator, calculations are always performed from left to right; the “multiplication and division before addition and subtraction rule” is ignored; in this case, every two operands and one operator form an intermediate result until a result can be determined.
2. If an intermediate result or result is a two-digit decimal number >18, only the units digit is used for the intermediate solution or solution.
3. There are a plurality of operands and a plurality of operators.
4. Only addition (+) and subtraction (−) are allowed as operators.
5. If the result of a calculation operation is <0, the number 10 is added to the first operand and is used for further calculation.
6. Operators for multiplication (*) and division (/) are integrated. However, they are used as placeholders, where (*) is used as the placeholder for addition and (/) is used as the placeholder for subtraction.

### Examples Include:

| Calculation | Solution | dopeIN | |
|---|---|---|---|
| problem | process | input code | Explanation of the solution |
| 3 [symbol] 4 [symbol] 9 + 1/2 = ? | 3 [symbol] 4 [symbol] 9 + 1/2 => | 5 | ( [symbol] ) is interpreted as ( [symbol] ). ( [symbol] ) is interpreted as ( [symbol] ). The units digit corresponds to the |
| | 3 + 4 [symbol] 9 + 1/2 => | | solution |
| | 7 [symbol] 9 + 1/2 => | | |
| | 7 + 9 + 1/2 => | | |
| | 16 + 1/2 => | | |
| | 16 + 1 − 2 => | | |
| | 17 − 2 = 15 | | |
| 1 − 9 [symbol] 3 = ? | 1 − 9 [symbol] 3 => | 5 | ( [symbol] ) is interpreted as ( [symbol] ). The intermediate result becomes <0, which is why 10 is |
| | 10 + 1 − 9 [symbol] 3 => | | added to the first operand. ( [symbol] ) is interpreted as ( [symbol] ). The units digit corresponds to |
| | 2 [symbol] 3 => | | the solution |
| | 2 + 3 = 5 | | |

[symbol]

indicates data missing or illegible when filed

Level 2c dopeIN Calculation Rules:

Note: The level 2a: (1-3 and 5) dopeIN calculation rules apply; points 4 and 6 are amended or supplemented:
1. Regardless of the operator, calculations are always performed from left to right; the “multiplication and division before addition and subtraction rule” is ignored; in this case, every two operands and one operator form an intermediate result until a result can be determined.
2. If an intermediate result or result is a two-digit decimal number >18, only the units digit is used for the intermediate solution or solution.
3. There are a plurality of operands and a plurality of operators.
4. Only addition (+), subtraction (−) and multiplication (*) are allowed as operators.
5. If the result of a calculation operation is <0, the number 10 is added to the first operand and is used for further calculation.
6. Division (/) is integrated. However, it is used as a placeholder for subtraction.

An example is:

| Calculation problem an | dopeIN input | |
|---|---|---|
| solution process | code | Explanation of the solution |
| 5/2 [symbol] 9 − 8 | 9 | |
| [symbol] | | ( [symbol] ) is interpreted as ( [symbol] ) |
| 5 −− 2 [symbol] 9 − 8 | | |
| [symbol] | | |
| 3 [symbol] 9 − 8 | | |
| [symbol] | | |
| 27 − 8 | | |
| [symbol] | | If the Intermediate result is a two-digit result and >18, the units digit is used for the |
| | | further calculation |
| 7 − 8 | | If the result is <0, 10 is added to the first operand |
| [symbol] | | |
| 10 + 7 − 8 | | |
| [symbol] | | |
| 17 − 8 = 9 | | The units digit corresponds to the solution |

[symbol]

indicates data missing or illegible when filed

dopeIN phrases 124 are used to define syntactic units which receive their value assignments technically and cognitively 102, 103 during dopeIN data processing 105, 106.

Examples: dopeIN Phrases

The following table lists examples of dopeIN phrases 124 and links them to a flag. For better understanding, the data type is also listed, but reference numbers are deliberately omitted.

| Value of the dopeIN | | Data | |
|---|---|---|---|
| phrase | Indicator | type | Comment |
| please | A | text | |
| EXTra | B | text | |
| sherp | C | text | |
| m1t | D | text | |
| S4hn3 | E | text | |
| {DDMMYYYY-hh:mm:ss} | F | text | dynamic assignment of |
| | | | system date and system |
| | | | time in the described |
| | | | format (e.g 25 Dec. |
| | | | 2017-11:11:11) |

With the aid of dopeIN patterns 119, temporary authentication data 109 can be generated (see dopeIN generation procedure 105) and analyzed and verified in the subsequent checking process (see dopeIN verification procedure 106).

dopeIN patterns 119 are divided into a plurality of levels. The levels are named as follows:
dopeIN viewing levels 122
dopeIN assignment levels 121

Only when the dopeIN user 101 knows the dopeIN pattern 119 with its levels 121, 122 in a security-related action 102 is the user able to correctly interpret the authentication data 109.

The generation and use of dopeIN patterns 119 is the responsibility of the dopeIN user 101 and, if necessary, is guided by the specifications of the dopeIN administration 116 that uses or implements the dopeIN method 1000.

The dopeIN viewing levels 122 deal with the individual views of the temporary authentication data 109. They focus on the selection of the different decimal numbers, operators and/or characters. In this case, references of the digit values of the display pairs to the digit values of the temporary dopeIN input code 112 are defined. Examples of different dopeIN viewing levels 122 are outlined below, in which case reference numbers were deliberately omitted.

### Examples: DopeIN Viewing Levels (Two-Line Display/Four-Digit Assignment)

Examples of dopeIN viewing levels 122 of a two-line dopeIN display of the authentication data 109, 110 and of the four-digit assignment for interpreting a dopeIN input code 112 to be solved are given below.
Reading is from left to right and from top to bottom.
The small numbers from 1-4 indicate the assignment to the decimal place of the dopeIN input code 112.

### Examples: DopeIN Viewing Levels (Four-Line Display/Individual Assignment)

The following examples illustrate dopeIN viewing levels 122 of a four-line dopeIN display 109, 110 and of the individual assignment for interpreting a dopeIN input code 112 to be solved.
Reading is from left to right and from top to bottom.
The small numbers from 1-8 indicate the assignment to the decimal place of the dopeIN input code 112.

### Examples: DopeIN Viewing Levels (Single-Line Display/Five-Digit Assignment)

The following examples list dopeIN viewing levels 122 of a single-line dopeIN display of the authentication data 109, 110 and of the five-digit assignment for interpreting a dopeIN input code 112 to be solved.
Reading is from left to right and from top to bottom.
The small numbers from 1-5 indicate the assignment to the decimal place of the dopeIN input code 112.

The dopeIN assignment levels 121 deal with the positioning of dopeIN sets of rules 120 and dopeIN viewing levels 122 that are assigned in the form of dopeIN assignment patterns 126. dopeIN phrases 124, operators, operands, intermediate results, results and dopeIN calculation rules 123 can be assigned. Specified dopeIN assignment patterns 126 can be used or individual dopeIN assignment patterns 126 can be stored as a basis for the assignments.

By assigning random values within dopeIN assignment patterns 126, the physical input 103 of the temporary dopeIN input code 112 is distributed over the entire input field. This makes it significantly more difficult to derive pressure marks (dirt profiles, finger marks, etc.).

When designing dopeIN assignment patterns 126, it is possible to interpret and assign a plurality of authentication codes and/or other software and/or hardware components as additional security levels (see [009]). All security fragments applied can be added to the authentication process in a parallel manner in a single step by inputting the dopeIN input code 112. This speeds up the authentication process.

In the case of technical authentication systems 100, which allow only one-line representations or no representations of the authentication data 109, 110, it makes sense to define a static operator. Statically stored alternating operators or operands, which follow a predefined static dopeIN assignment pattern 126, are also possible here. It is also possible to use a random operand or a random result. The interpretation and assignment of a 2FA code and/or other software and/or hardware components as supplementary security elements can also be used (cf. [009]).

### Examples of Static dopeIN Assignment Patterns

### Example 1

The following table shows, by way of example, the positioning and assignment options for two operands, one operator, the result and an eight-digit authentication code 108 by means of a single-line authentication data display 109, 110, in which case reference numbers were deliberately omitted in the table and description.

The following applies:
Fields named result represent the dopeIN display.
Fields named operand 2 represent the dopeIN input code and are marked with dopeIN[ ].
The operator has been defined as a static dopeIN assignment pattern which is marked with ( ); it is ++−−+−−+.
Random values are marked with { }.
The authentication code is static, marked with PIN, and is 47110815.
The dopeIN viewing level labeled vertical applies.
The level 1a dopeIN calculation rules apply.

| | | Digit value of the dopeIN input code | | | | | | | |
|---|---|---|---|---|---|---|---|---|---|
| | | 1 ⇒ | 2 ⇒ | 3 ⇒ | 4 ⇒ | 5 ⇒ | 6 ⇒ | 7 ⇒ | 8 ⇒ |
| Name: | Positioning: | 10⁷ | 10⁶ | 10⁵ | 10⁴ | 10³ | 10² | 10¹ | 10⁰ |
| Operand 1 | PIN | 4 | 7 | 1 | 1 | 0 | 8 | 1 | 5 |
| Operator 1 | (static dopeIN assignment pattern) | (+) | (+) | (−) | (−) | (+) | (−) | (−) | (+) |
| Operand 2 | dopeIN[ ] | [9] | [1] | [0] | [4] | [0] | [4] | [6] | [8] |
| Result | {0 . . . 9} | {3} | {8} | {1} | {7} | {0} | {4} | {5} | {3} |

### Example 2

The following table shows, by way of example, the positioning and assignment options for two operands, one operator, the result and an eight-digit authentication code 108 without publication/display of the temporarily generated authentication data 109, in which case reference numbers were deliberately omitted in the table and description.

The following applies:
The operator has been defined as a static dopeIN assignment pattern which is marked with ( ); it is +−+−+−+−.
Fields named operand 2 represent the dopeIN input code and are marked with dopeIN[ ].
The authentication code is static, marked with PIN, and is 47110815.
The result is dynamic, marked with {DDMMhhmm}, and refers to the current date and time, here 16031255.
The dopeIN viewing level labeled vertical applies.
The level 1a dopeIN calculation rules apply.

| | | Digit value of the dopeIN input code | | | | | | | |
|---|---|---|---|---|---|---|---|---|---|
| | | 1 ⇒ | 2 ⇒ | 3 ⇒ | 4 ⇒ | 5 ⇒ | 6 ⇒ | 7 ⇒ | 8 ⇒ |
| Name: | Positioning: | 10⁷ | 10⁶ | 10⁵ | 10⁴ | 10³ | 10² | 10¹ | 10⁰ |
| Operand 1 | PIN | 4 | 7 | 1 | 1 | 0 | 8 | 1 | 5 |
| Operator 1 | (static dopeIN assignment pattern) | (+) | (−) | (+) | (−) | (+) | (−) | (+) | (−) |
| Operand 2 | dopeIN[ ] | (7) | [1] | [9] | [8] | [1] | [6] | [4] | [0] |
| Result | {DDMMhhmm} | {1} | {6} | {0} | {3} | {1} | {2} | {5} | {5} |

### Example 3

The following table shows, by way of example, the use of an individual dopeIN phrase 124, in which case reference numbers were deliberately omitted in the table and description.

The following applies:
Random values are marked with { }.
Fields named dopeIN[ ] represent the dopeIN input code.
The secret secure authentication code is marked with CODE and is myPASSword.
The individual dopeIN phrase is marked with
   !!,
   is SuPeR,
   and is inserted after the second digit of the authentication code.

| Fragments of | | |
|---|---|---|
| the dopeIN data | | |
| processing | Name: | Value of the fragment |
| Fragment 1 | CODE | myPASSword |
| Fragment 2 | !Individual dopeIN phrase! | !SuPer! |
| | | [symbol] |
| | [symbol] | dopeIN input code |
| | dopeIN[ ] | [mySuPerPASSword] |

[symbol]

indicates data missing or illegible when filed

A further security factor is the use of dynamic dopeIN assignment patterns 126. Each security fragment that is dynamically integrated into the authentication process provides increased protection against unjustifiable access to a security-related system action 102.

### Examples of Dynamic dopeIN Assignment Patterns

### Example 1

Example 1 shows the positioning and assignment options for two operands, one operator, the result and a three-digit authentication code 108, in which case reference numbers were deliberately omitted in the table and description.

The following applies:
Fields named operand 1 and operator represent the dopeIN display.
Fields named operand 2 represent the dopeIN input code and are marked with dopeIN[ ].
Random values are marked with { }.
The result is static, represents the authentication code, is marked with PIN, and is 449.
The dopeIN viewing level labeled vertical applies.
The level 1a dopeIN calculation rules apply.

| | | Digit value of the dopeIN input code | | |
|---|---|---|---|---|
| | | 1 ⇒ | 2 ⇒ | 3 ⇒ |
| Name: | Positioning | 10² | 10¹ | 10⁰ |
| Operand 1 | {0 . . . 9} | {7} | {7} | {5} |
| Operator | {+, −} | {+} | {−} | {−} |
| Operand 2 | dopeIN[ ] | [7] | [3] | [6] |
| Result | PIN | 4 | 4 | 9 |

### Example 2

The following table shows, by way of example, the positioning and assignment options for three operands, one operator, the result and a three-digit authentication code 108, in which case reference numbers were deliberately omitted in the table and description.

The following applies:
Fields named operand 1 and operand 2 and operator 1 and operator 2 represent the dopeIN display.
Fields named operand 3 represent the dopeIN input code and are marked with dopeIN[ ].
Random values are marked with { }.
The result is static, represents the authentication code, is marked with PIN, and is 333.
The dopeIN viewing level labeled vertical_big applies.
The level 2a dopeIN calculation rules apply.

| | | Digit value of the dopeIN input code | | |
|---|---|---|---|---|
| | | 1 ⇒ | 2 ⇒ | 3 ⇒ |
| Name: | Positioning: | 10² | 10¹ | 10⁰ |
| Operand 1 | {0 . . . 9} | {9} | {9} | {9} |
| Operator 1 | {+, −} | {−} | {+} | {+} |
| Operand 2 | {0 . . . 9} | {5} | {5} | {9} |
| Operator 2 | {+, −} | {+} | {−} | {+} |
| Operand 3 | dopeIN[ ] | [9] | [1] | [5] |
| Result | PIN | 3 | 3 | 3 |

Individual dopeIN assignment patterns 126 provide dopeIN users 101 with the greatest possible freedom in assigning dopeIN viewing levels 122, dopeIN calculation rules 123 and dopeIN phrases 124. The creativity of each individual dopeIN user 101 can thus be profitably incorporated into the individual algorithm-based multifactor authentication (dopeIN) 1000.

### Examples of Individual dopeIN Assignment Patterns

### Example 1

Example 1 shows the use of dynamic operators determined on the basis of a 6-digit 2FA code (cf. [009]), in which case reference numbers were deliberately omitted in the table and description.

The following is defined as an individual dopeIN assignment pattern:
If the respective decimal place of the 2FA code (cf. [009]) is even, an addition follows, and if it is odd, this leads to subtraction. If the decimal number is 0, a multiplication or division is randomly generated.

The following applies:
Fields named operator 1 and result represent the dopeIN display.
Fields named operand 2 represent the dopeIN input code and are marked with dopeIN[ ].
Random values are marked with { }.
Operand 1 is static, represents the authentication code, is marked with PIN, and is 753219.
The dopeIN viewing level labeled vertical applies.
The level 1b dopeIN calculation rules apply.
There is an individual dopeIN assignment pattern that meets the above-mentioned requirement; this is marked with!!.

Digit value of the dopeIN input code

| | | Digit value of the dopeIN input code | | | | | |
|---|---|---|---|---|---|---|---|
| | | 1 ⇒ | 2 ⇒ | 3 ⇒ | 4 ⇒ | 5 ⇒ | 6 ⇒ |
| Name: | Positioning: | 10⁵ | 10⁴ | 10³ | 10² | 10¹ | 10⁰ |
| Operand 1 | PIN | 7 | 5 | 3 | 2 | 1 | 9 |
| Operator 1 | lindividual | !4! | !3! | !1! | !8! | !0! | !2! |
| | dopeIN assignment | [symbol] | [symbol] | [symbol] | [symbol] | [symbol] | [symbol] |
| | pattern! | | | | | | |
| Operand 2 | dopeIN[ ] | [4] | [4] | [1] | [5] | [5] | [4] |
| Result | {0 . . . 9} | {1} | {1} | {2} | {7} | {6} | {3} |

### Example 2

In this case, the current system date (DD.MM) is dynamically assigned to the second operator, in this case 13.03. Reference numbers were deliberately omitted in the table and description.

The following applies:
Fields named operator 1 represent the dopeIN display.
Fields named result represent the dopeIN input code and are marked with dopeIN[ ].
Random values are marked with { }.
Operand 1 is static, represents the authentication code, is marked with PIN, and is 0815.
The dopeIN viewing level labeled vertical applies.
The level 1a dopeIN calculation rules apply.
There is an individual dopeIN assignment pattern that meets the above-mentioned requirements; this is marked with!!.

| | | Digit value of the dopeIN input code | | | |
|---|---|---|---|---|---|
| | | 1 ⇒ | 2 ⇒ | 3 ⇒ | 4 ⇒ |
| Name: | Positioning: | 10³ | 10² | 10¹ | 10⁰ |
| Operand 1 | PIN | 0 | 8 | 1 | 5 |
| Operator 1 | {+, −} | {+} | {−} | {+} | {+} |
| Operand 2 | !individual dopeIN | !1! | !3! | !0! | !3! |
| | assignment pattern! | | | | |
| Result | dopeIN[ ] | [1] | [5] | [1] | [8] |

### Example 3

In this example, the current system time (hh:mm) is dynamically assigned to the second operator, in this case 16:55. In addition, the position of the dopeIN input code 112 for each decimal place changes on the basis of a previously defined positioning flag.

The following table shows, by way of example, all permutations with their respective assignment, which can result when using two operands and one operator, and assigns a positioning indicator. Reference numbers were deliberately omitted in tables and the description.

The following applies:
The fields operand 1 B & C, operator A to F, operand 2 A & D and result E & F represent the dopeIN display.
The fields operand 1 D & F, operand 2 C & E and result A & B represent the dopeIN input code and are marked with dopeIN[ ].
Random values are marked with { }.
The secret secure authentication code is marked with PIN.

| | Positioning indicator | | | | | |
|---|---|---|---|---|---|---|
| Name: | A | B | C | D | E | F |
| Operand 1 | PIN | {0 . . . 9} | {0 . . . 9} | dopeIN[ ] | PIN | dopeIN[ ] |
| Operator | {+, −} | {+, −} | {+, −} | {+, −} | {+, −} | {+, −} |
| Operand 2 | {0 . . . 9} | PIN | dopeIN[ ] | {0 . . . 9} | dopeIN[ ] | PIN |
| Result | dopeIN[ ] | dopeIN[ ] | PIN | PIN | {0 . . . 9} | {0 . . . 9} |

For the individual dopeIN assignment pattern, the following applies:
Fields named operator 1 represent the dopeIN display.
The fields operand 1 D & D and result A & A represent the dopeIN input code.
Random values are marked with { }.
The authentication code is static, marked with PIN, and is 4711.
The dopeIN viewing level labeled vertical applies.
The level 1a dopeIN calculation rules apply.
There is an individual dopeIN assignment pattern that meets the above-mentioned requirements; this is marked with!!. The current time is 16:55.
The operands, the authentication code and the result are individually assigned for each decimal place on the basis of the positioning flag.

| | | Digit value of the dopeIN input code | | | |
|---|---|---|---|---|---|
| | | 1 ⇒ | 2 ⇒ | 3 ⇒ | 4 ⇒ |
| | | 10³ | 10² | 10¹ | 10⁰ |
| Name: | Positioning according to positioning indicator: | A | D | D | A |
| Operand 1 | individual determination for each decimal place | 4 | [3] | [6] | 1 |
| Operator 1 | individual determination for each decimal place | {−} | {−} | {+} | {+} |
| Operand 2 | !individual dopeIN assignment pattern! | !1! | !6! | !5! | !5! |
| Result | individual determination for each decimal place | [3] | 7 | 1 | [6] |

### Example 4

Example 4 shows, by way of example, the positioning and assignment options for two operands, one operator, the result and an 8-digit authentication code 108 on a single-line authentication data display 109, 110. Static dopeIN assignment patterns 126 for the operator and individual dopeIN assignment patterns 126 for the applicable dopeIN calculation rules 123 are used. Reference numbers were deliberately omitted in the table and description.

The following applies:
Fields named result represent the dopeIN display.
Fields named operand 2 represent the dopeIN input code and are marked with dopeIN[ ].
The operator was defined as a static dopeIN assignment pattern. This is marked with ( ) It is +*−//**/.
Random values are marked with { }.
Operand 2 is static, represents the authentication code, is marked with PIN and is 47110815.
The dopeIN viewing level labeled vertical applies.
An individually assigned dopeIN calculation rule applies for each decimal place.

| | | Digit value of the dopeIN input code | | | | | | | | |
|---|---|---|---|---|---|---|---|---|---|---|
| | | 1 ⇒ | 2 ⇒ | 3 ⇒ | 4 ⇒ | 5 ⇒ | 6 ⇒ | 7 ⇒ | 8 ⇒ | |
| | | 10⁷ | 10⁶ | 10⁵ | 10⁴ | 10³ | 10² | 10¹ | 10⁰ | ⇐ dopeIN |
| Name: | Positioning: | 1a | 1b | 1a | 1b | 1a | 1b | 1a | 1b | calculation rule |
| Operand 1 | PIN | 4 | 7 | 1 | 1 | 0 | 8 | 1 | 5 | |
| Operator 1 | (static dopeIN | (+) | (*) | (−) | (/) | (/) | (*) | (*) | (/) | |
| | assignment pattern) | | | | | | | | | |
| Operand 2 | dopeIN[ ] | [9] | [7] | [0] | [4] | [0] | [6] | [4] | [2] | |
| Result | {0 . . . 9} | {3} | {4} | {1} | {7} | {0} | {4} | {5} | {3} | |

### Example 5

Example 5 shows the use of an individual dopeIN phrase 124 which is dynamically adjusted and added at a specific place of the secure authentication code 108. Another individual dopeIN phrase 124 is assigned by means of the table: Examples: dopeIN phrases (cf. [041]) and added at the end of the authentication code 108. There is no publication/display of temporarily generated authentication data 109. Reference numbers were deliberately omitted in the table and description.

The following applies:
Fields named dopeIN[ ] represent the dopeIN input code.
The secret secure authentication code is marked with PASSWORD and is my&&word.
The secret individual dopeIN phrase
   is marked with!!,
   is inserted after the first & character of the authentication code,
   is dynamic and corresponds to today's system date (DDMM), here 24.12.
Another individual dopeIN phrase is
   assigned with the aid of the individual table Examples: dopeIN phrases/indicators: B, here EXTra,
   marked with!!,
   and inserted at the last place of the authentication code.

| Fragments of | | |
|---|---|---|
| dopeIN data | | |
| processing | Name: | Value of the fragment |
| Fragment 1 | PASSWORD | my&&word |
| Fragment 2 | !individual dopeIN phrase! | !2412! |
| Fragment 3 | !Examples: phrases/indicators: | !EXTra! |
| | B! | |
| | [symbol] | [symbol] |
| | | dopeIN input code |
| | dopeIN[ ] | [my&2412&wordEXTra] |

### Example 6

Example 6 shows the use of an individual dopeIN phrase 124 which is dynamically adjusted and added at a specific place of the secure authentication code 108. The dynamic adjustment is performed here by means of a plurality of data processing operations. Reference numbers were deliberately omitted in the table and description.

The following applies:
Fields named operator 1 represent the dopeIN display.
Fields named dopeIN[ ] represent the dopeIN input code.
Random values are marked with { }.
The authentication code is marked with CODE and is pa { } s { } st.
Operand 1 is static, represents another authentication code, is marked with PIN, and is 1357.
The secret individual dopeIN phrase
   is marked with!!,
   replaces all { } characters of the authentication code,
   is determined with the aid of the global level 1a dopeIN calculation rules,
   is dynamic and corresponds to the system time (hhmm), here 11:55.

Step 1 of the dynamic data processing

| | | Digit values of the | | | |
|---|---|---|---|---|---|
| | | dopeIN intermediate values | | | |
| | | 1 ⇒ | 2 ⇒ | 3 ⇒ | 4 ⇒ |
| Name: | Positioning: | 10³ | 10² | 10¹ | 10⁰ |
| Operand 1 | PIN | 1 | 3 | 5 | 7 |
| Operator 1 | {+, −} | {+} | {−} | {+} | {+} |
| Operand 2 | !individual dopeIN assignment pattern! | !1! | !1! | !5! | !5! |
| Intermediate result | !individual dopeIN phrase! | [2] | [2] | [0] | [2] |

Step 2 of the dynamic data processing:

| Fragments of the | | |
|---|---|---|
| dopeIN data processing | Name: | Value of the fragment: |
| Fragment 1 | CODE | pa [symbol] st |
| Fragment 2 | !Value of the individual dopeIN phrase from step 1! | !2202! |
| | | [symbol] |
| | [symbol] | dopeIN input code |
| | dopeIN[ ] | [pa2202s2202st] |

[symbol]

indicates data missing or illegible when filed

The dopeIN user 101 can directly influence the dopeIN display 110. This allows the dopeIN user 101 to make optical flags that allow the user to recognize whether the dopeIN display 110 was generated by a legitimate technical authentication system 100.

In order to protect against phishing (see [008]), the dopeIN user 101 can define with the aid of a dopeIN assignment pattern 126 that certain characters and/or numbers of the dopeIN display 110 appear in a specific color, background color or font. If these individually selected flags are not fulfilled by the technical system 101, the dopeIN user 101 can immediately see and expect that the technical authentication system 100 has been corrupted.

It is up to the competence and creativity as well as the experience of the respective dopeIN user 101 to define his or her own dopeIN[algorithm templates] 125 and to generate dopeIN algorithms 107 from them. There is a variety of permutations and forms of these security fragments. Here, the description describes possibilities and presents them in a roughly exemplary manner.

Further security fragments are integrated into the authentication process through the use of individual algorithm-based multifactor authentication (dopeIN) 1000. Therefore, it is not necessary to newly create and/or continuously modify the authentication code 108. This automatically increases the acceptance of the individual system user 101 to use individual algorithm-based multifactor authentication (dopeIN) 1000.

Likewise, the standardized intervals for changing authentication codes 108, which may already be specified by the dopeIN administration 116, can be increased.

The individual security needs of the dopeIN user 101 and/or of the dopeIN administration 116 are addressed and technically represented as a separate security fragment 107 through the use of individual algorithm-based multifactor authentication (dopeIN) 1000. It can be implemented 2000 in technical authentication and security systems 100, 200 and used 3000 within technical authentication systems 100. At the same time, an underlying variability is ensured, as a result of which future cryptographic security techniques, methods and enhancements can be flexibly integrated. The flexibility and adjustability of individual algorithm-based multifactor authentication (dopeIN) 1000 with regard to user needs should promote acceptance among a wide variety of users.

### Sources for the Prior Art are

| Reference number | Brief description |
|---|---|
| CH 713 015 A2 | Input device and method |
| DE 296 13 938 U1 | Code input system for credit card payment systems and ATMs |
| DE 10 2004 002 128 A1 | Device and method for coded and/or non-coded commands |
| DE 10 2008 019 034 A1 | Method and device for determining an access code |
| DE 10 2009 020 207 A1 | Input terminal and PIN capture method |
| DE 10 2009 012 011A1 | PIN or password input system for daily use in department stores |
| | to ensure discretion |
| U.S. Pat. No. 9,686,275 B2 | Correlating cognitive biometrics for continuous identify |
| | verification |
| U.S. Pat. No. 9,672,335 B2 | Cognitive-based logon process for computing device |
| U.S. Pat. No. 10,476,873 B2 | Device, system, and method of password-less user authentication |
| | and password-less detection of user identity |
| EP 1 010 049 B1 | Generalized user identification and authentication system |

### LIST OF REFERENCE SIGNS

No. Designations
1000 Individual algorithm-based multifactor authentication (for short: dopeIN or dopeIN method)
2000 Implementation phase
3000 Application phase
100, 200 Technical authentication and security system
101 Individual system user=human=system user=dopeIN user
102 Legitimacy=system access to a security-related action
103 Input
104 dopeIN user data
105 dopeIN data processing⇒dopeIN generation procedure
106 dopeIN data processing⇒dopeIN verification procedure
107 dopeIN algorithm
108 Authentication code
109 Temporary authentication data=dopeIN display or dopeIN authentication data
110 Optional display of the temporary dopeIN authentication data
111 Input prompt
112 Input data=temporary dopeIN input code
113 Temporary result of the dopeIN authentication check
114 Steps on the basis of the temporary result of the dopeIN authentication check
115 Technical elements/aids
116 dopeIN administration
117 Synchronization processes=native “method for storing secret authentication data and their use”
118 Generate/select
119 dopeIN pattern
120 dopeIN sets of rules
121 dopeIN assignment levels
122 dopeIN viewing levels
123 dopeIN calculation rules
124 dopeIN phrase
125 dopeIN[algorithm templates]
126 dopeIN assignment pattern
127 Generate a dopeIN algorithm

1. A method (1000) for performing an authentication process (3000) by an individual system user (101), using technical security systems (200) which comprise hardware and software and are intended to generate, manage and execute an authentication algorithm (107), formed from security fragments, of individual algorithm-based multifactor authentication, on a technical authentication system (100) requiring authentication,
characterized by
(a) the implementation (2000) of security fragments using the technical security system (200) by an administrator (116) and/or a system user (101) individualizing the authentication process at least in the form of patterns (119) and/or sets of rules (120) and/or algorithm templates (125) for generating an algorithm (127) for performing the authentication process (3000) within a technical authentication system (100) requiring the authentication (102),
(b) the management (2000) of the implemented security fragments by the administrator (116) and/or the individual system user (101) within the technical security system (200),
(c) the generation (2000) of the authentication algorithm (107) from implemented security fragments (119 to 126) by the individual system user (101) and the linking of this authentication algorithm (107) to an authentication code (108) determined by the individual system user (101), wherein the authentication algorithm (107) with authentication code (108) is assigned to a defined technical authentication system (100) by the individual system user (101),
(d) performance (3000) of the authentication process by legitimizing (102) the individual system user (101) on a technical authentication system (100) that is selected by the system user (101) and requires authentication (102),
and automatically generating (105) temporary authentication data (109) based on the authentication algorithm (107) stored in the technical security system (200) for this technical authentication system (100) with reference to the authentication code (108) and transmitting said data to the individual system user (101),
wherein data are exchanged between the technical security system (200) managing the authentication algorithm (107) with authentication code (108) and the technical authentication system (100) requiring authentication by way of synchronization processes (117) for exchanging non-public data,
(e) use of the authentication algorithm (107) in conjunction with the authentication code (108) by the individual system user (101) for the purpose of converting the temporary authentication data (109) into a temporary input code (112) for input (103) and authentication (3000) of the individual system user (101) on the technical authentication system (100), and
(f) performance of an authentication check (106) of the temporary input code (112) input by the individual system user (101) by the technical security system (200), with the inclusion of the generated temporary authentication data (109), and use of the authentication code (108) generated by the individual system user (101) and the authentication algorithm (107) for generating a temporary result (113) of the authentication check (106) for triggering defined steps of the system process (114) on the basis of this temporary result (113) of the authentication check (106).

2. The method (1000) for performing an authentication process (3000) as claimed in claim 1,
characterized in that
established known cryptographic security mechanisms are integrated into the method in order to implement the security fragments and/or to automatically generate (2000) and/or execute (3000) the security fragments.

3. The method (1000) for performing an authentication process (3000) as claimed in claim 1 or 2,
characterized in that
the complexity of the authentication process (3000) with user interaction (118) is scalable and can be determined by the individual system user (101) when implementing (2000) the security fragments (107, 119 to 126) for the authentication process (102).

4. The method (1000) for performing an authentication process (3000) as claimed in any one of the preceding claims,
characterized in that
a plurality of security techniques are processed in a single step in a parallel manner by means of a single input (103) by the individual system user (101).

5. The method (1000) for performing an authentication process (3000) as claimed in any one of the preceding claims,
characterized in that
the physical input (103) of the temporary input code (112) takes place in an input field and is requested and input in a manner distributed over the entire input field during use.

6. The method (1000) for performing an authentication process (3000) as claimed in any one of the preceding claims,
characterized in that
existing authentication codes (108) can be integrated into the authentication process and can thus be retained.

7. The method (1000) for performing an authentication process (3000) as claimed in any one of the preceding claims,
characterized in that
an individual system user (101) can already recognize, during the input prompt (111) of a requesting authentication system (100), by comparing the security fragments implemented by the individual system user (101) for the input prompt (111), whether the requesting authentication system (100) has the legitimacy to create the input prompt (111).

8. The method (1000) for performing an authentication process (3000) as claimed in any one of the preceding claims,
characterized in that
the security fragments for the individual algorithm-based multifactor authentications (1000), depending on how the individual algorithm-based multifactor authentication (1000) is implemented by the administration (116), are generated, managed (2000) and/or executed (3000) inside and/or outside the system.

9. The method (1000) for performing an authentication process (3000) as claimed in any one of the preceding claims,
characterized in that
the individual system user (101) generates (118) algorithm templates (125) by means of technical elements and/or aids (115) and implements the applicable authentication algorithm (107) in the authentication process (3000) in a manner adapted to his or her cognitive abilities, wherein the patterns (119) and sets of rules (120) can be individually combined with algorithm templates (125) and these algorithm templates (125) form the basis for generating (127) the algorithms (107) of the authentication process (3000).

10. The method (1000) for performing an authentication process (3000) as claimed in any one of the preceding claims,
characterized in that
the individual system user (101) defines and/or selects (118) user data (104), algorithms (107), patterns (119), sets of rules (120), assignment levels (121), viewing levels (122), calculation rules (123), phrases (124), algorithm templates (125) and assignment patterns (126) for the purpose of generating (127) the algorithms (107).

11. The method (1000) for performing an authentication process (3000) as claimed in any one of the preceding claims,
characterized in that
the patterns (119) consist of viewing levels (122) and assignment levels (121), wherein these assignment levels (121) include assignment patterns (126) and
the sets of rules (120) consist of phrases (124) and/or calculation rules (123).

12. The method (1000) for performing an authentication process (3000) as claimed in any one of the preceding claims,
characterized in that
an authentication algorithm (107) consists of at least one user-defined generation procedure (105) and at least one user-defined verification procedure (106).

13. A program product (115) for performing an authentication process (3000) according to the method (1000) as claimed in any one of claims 1 to 12 for completely or partially managing and generating
user data (104), algorithms (107), patterns (119), sets of rules (120), assignment levels (121), viewing levels (122), calculation rules (123), phrases (124), algorithm templates (125) and assignment patterns (126), with instructions executable by a technical security system (200) and a technical authentication system (100) and the synchronization (117) of the authentication algorithm (107) between the technical security system (200) and the authentication system (100).

14. A computer program for performing an authentication process (3000) according to the method (1000) as claimed in any one of claims 1 to 12,
wherein the computer program runs on technical data processing machines as a technical security and authentication system (100, 200).

15. A technical construction for performing an authentication process (3000) according to the method (1000) as claimed in any one of claims 1 to 12,
wherein the technical construction comprises mechanical and/or electronic locks and/or locking systems and the technical security and authentication systems (100), (200) for applying the individual algorithm-based multifactor authentication (1000) with access to the mechanical and/or electronic locks and/or locking systems.
